(19) United States
(12) Patent Application Publication
(10) Pub. No.: US 2026/0216795 A1
(43) Pub. Date: Jul. 30, 2026

(54) CUTTING TOOL, AND METHOD FOR MANUFACTURING MACHINED PRODUCT

(71) Applicant: KYOCERA CORPORATION, Kyoto (JP)

(72) Inventor: Yuki YOSHIKI, Kyoto (JP)

(21) Appl. No.: 19/143,893

(22) PCT Filed: Nov. 28, 2023
(86) PCT No.: PCT/JP2023/042455

§ 371 Date: Jun. 27, 2025

(30) Foreign Application Priority Data
Jan. 6, 2023 (JP) 2023-001143

(51) Int. Cl. B23B 29/04; B23B 27/16

(52) U.S. Cl. CPC B23B 29/04; B23B 27/1677

(57) ABSTRACT

A cutting tool having high accuracy of positioning an insert is awaited. A cutting tool according to an aspect of the present disclosure is a cutting tool extending from a front end toward a rear end and includes a holder including a pocket located on a side of the front end, an insert to be attached to the pocket, and a plurality of fixtures for fixing the insert to the pocket. The insert has a first surface and a second surface located on an opposite side of the first surface and includes a through hole opening in the first surface and the second surface and a first recessed portion located in the first surface. The plurality of fixtures include a first fixture inserted into the through hole and a second fixture engaged with the first recessed portion.

### TECHNICAL FIELD

The present disclosure relates to a cutting tool and a method for manufacturing a machined product.

### BACKGROUND OF INVENTION

Examples of a known cutting tool to be used in machining a workpiece include cutting tools described in Patent Documents 1 to 3. Each of the cutting tools described in Patent Documents 1 to 3 includes an insert, a holder, and a clamper. When including the clamper, the cutting tool allows the insert to be pulled-in toward a restraint surface side of the holder by the clamper and can enhance accuracy of positioning the insert.

### CITATION LIST

### Patent Literature

Patent Document 1: JP 2007-144525 A

Patent Document 2: WO 2018/172218

Patent Document 3: JP 2009-095918 A

### SUMMARY

A cutting tool according to an aspect of the present disclosure is a cutting tool extending from a front end toward a rear end along a reference axis and includes: a holder including a pocket located on a side of the front end; an insert to be attached to the pocket; and a plurality of fixtures for fixing the insert to the pocket. The insert has a first surface and a second surface located on an opposite side of the first surface and includes a through hole opening in the first surface and the second surface and a first recessed portion located in the first surface. The plurality of fixtures include a first fixture inserted into the through hole and a second fixture engaged with the first recessed portion.

### BRIEF DESCRIPTION OF THE DRAWINGS

FIG. 1 is a perspective view illustrating a cutting tool according to a first embodiment.

FIG. 2 is an exploded perspective view illustrating the cutting tool according to the first embodiment.

FIG. 3 is a plan view of the cutting tool according to the first embodiment, as viewed in a front view from a first surface side, that is, from above.

FIG. 4 is a plan view of the cutting tool according to the first embodiment, as viewed from a right side.

FIG. 5 is an enlarged view corresponding to region A1 illustrated in FIG. 3.

FIG. 6 is an enlarged view corresponding to region A2 illustrated in FIG. 4, in a cross-section taken along line VI-VI in FIG. 5.

FIG. 7 is a perspective view illustrating a cutting tool according to a second embodiment.

FIG. 8 is a plan view of the cutting tool according to the second embodiment, as viewed in a front view from a first surface side, that is, from above.

FIG. 9 is an enlarged view corresponding to region A3 illustrated in FIG. 8.

FIG. 10 is a perspective view illustrating a cutting tool according to a third embodiment.

FIG. 11 is an exploded perspective view illustrating the cutting tool according to the third embodiment.

FIG. 12 is a plan view of the cutting tool according to the third embodiment, as viewed in a front view from a first surface side, that is, from above.

FIG. 13 is a plan view of the cutting tool according to the third embodiment, as viewed from a right side.

FIG. 14 is an enlarged view corresponding to region A4 illustrated in FIG. 12.

FIG. 15 is an enlarged view corresponding to region A5 illustrated in FIG. 13, in a cross-section taken along line XV-XV in FIG. 14.

FIG. 16 is a schematic view illustrating a process of a method for manufacturing a machined product according to an embodiment.

FIG. 17 is a schematic view illustrating a process of the method for manufacturing a machined product according to an embodiment.

FIG. 18 is a schematic view illustrating a process of the method for manufacturing a machined product according to an embodiment.

### DESCRIPTION OF EMBODIMENTS

In the following, detailed description will be made of cutting tools according to non-limiting first to third embodiments of the present disclosure with reference to the drawings. However, each of the figures, which will be referred to below, is a simplified representation of only main members necessary for description of the embodiment. Thus, the cutting tool according to the present disclosure may include any component member not illustrated in each of the figures referred to. The dimensions of members in the respective figures do not accurately represent the actual dimensions of constituent members, the dimensional ratio of respective members, or the like.

In the cutting tools described in Patent Documents 1 and 2, since the pressing toward a seat surface direction is performed simultaneously with the pulling-in toward the restraint surface side, a gap may be generated between the insert and the restraint surface. In the cutting tool described in Patent Document 3, since fixing is first performed by a screw, the insert may be attached inclined because it is first fixed by a screw. A cutting tool according to an aspect of the present disclosure has high accuracy of positioning the insert.

### Cutting Tool

### First Embodiment

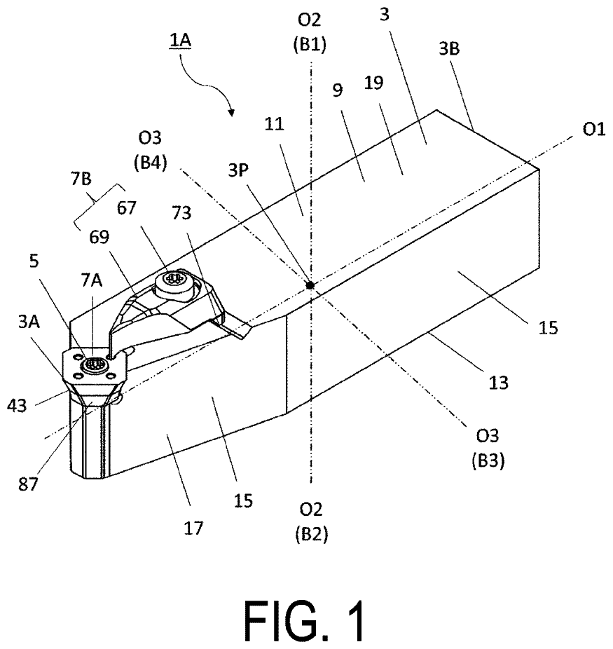

As illustrated in FIGS. 1 to 6, a cutting tool 1A of a first embodiment includes a holder 3, a cutting insert 5, and a plurality of fixtures 7. The cutting insert 5 will hereinafter be referred to as an insert 5. The cutting tool 1A of the first embodiment extends along a reference axis O1 from a first end 3A to a second end 3B. The first end 3A may also be referred to as a front end 3A. The second end 3B may also be referred to as a rear end 3B. In the cutting tool 1A of the first embodiment, the reference axis O1 is a central axis of the cutting tool 1A. As the side of the first end 3A is illustrated in FIG. 1, the shape of the cutting tool 1A is not limited, but the cutting tool 1A of the first embodiment has a quadrilateral pillar shape. Note that the quadrilateral pillar shape is not a strict quadrilateral pillar shape, and may include a hole or a groove in a part thereof, for example.

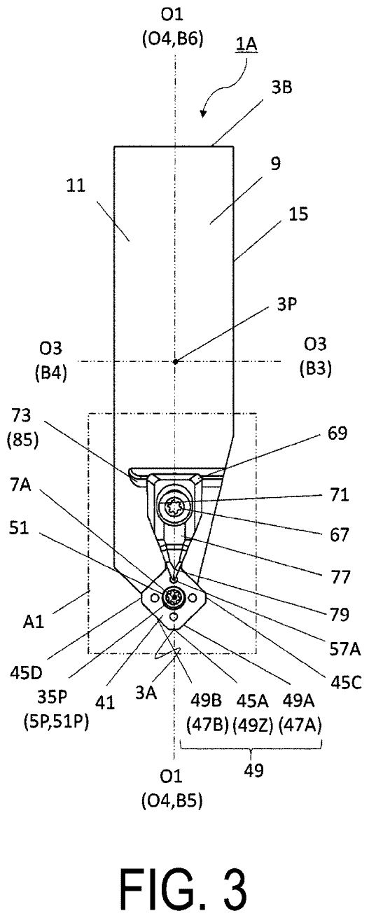

The holder 3 may include a body portion 9. As illustrated in FIG. 1 and the like, the body portion 9 of the first embodiment may have a shape extending along the reference axis O1 from the first end 3A to the second end 3B. As illustrated in FIG. 3, the body portion 9 of the first embodiment has a pillar shape, more specifically, a quadrilateral pillar shape. Note that the shape of the body portion 9 is not limited to the quadrilateral pillar shape, and may be a circular pillar shape, for example.

The body portion 9 may have an upper surface 11, a lower surface 13, and a side surface 15. The body portion 9 of the first embodiment has an upper surface 11, a lower surface 13, and a plurality of side surfaces 15. The lower surface 13 is a surface located on an opposite side of the upper surface 11, and the side surface 15 is a surface located between the upper surface 11 and the lower surface 13. The shapes of the upper surface 11, the lower surface 13, and the side surface 15 are not limited but may be, for example, a quadrilateral shape. Note that the quadrilateral shape is not a strict quadrilateral shape and may include a hole or a groove in a part thereof, for example.

The body portion 9 may include a head 17 located on the side of the first end 3A and a shank 19 located on the side of the second end 3B. The head 17 is a portion to which the insert 5 is attached. The shank 19 is a portion that is gripped by a machine tool. The body portion 9 of the first embodiment has a configuration in which the head 17 and the shank 19 are integrated, but the head 17 and the shank 19 may be configured by separate members. When the head 17 and the shank 19 are configured by separate members, the head 17 may be brazed to the shank 19 by, for example, a brazing material, or one may be fixed to the other by, for example, a screw or the like.

The shank 19 in the example illustrated in FIG. 1 and the like has a quadrilateral pillar shape. When the body portion 9 includes the shank 19 having such a quadrilateral pillar shape, a central axis of the shank 19 may be regarded as the reference axis O1 of the cutting tool 1A. In the above-described case, the central axis of the shank 19 passing through a center of the rear end surface of the shank 19 and extending in a direction parallel to four side surfaces of the shank 19 may be regarded as the reference axis O1.

The holder 3 may include a pocket 21 located on a side of the first end 3A. The pocket 21 may be located in the head 17. In the holder 3 of the first embodiment, the pocket 21 is a recessed portion to which the insert 5 is attached.

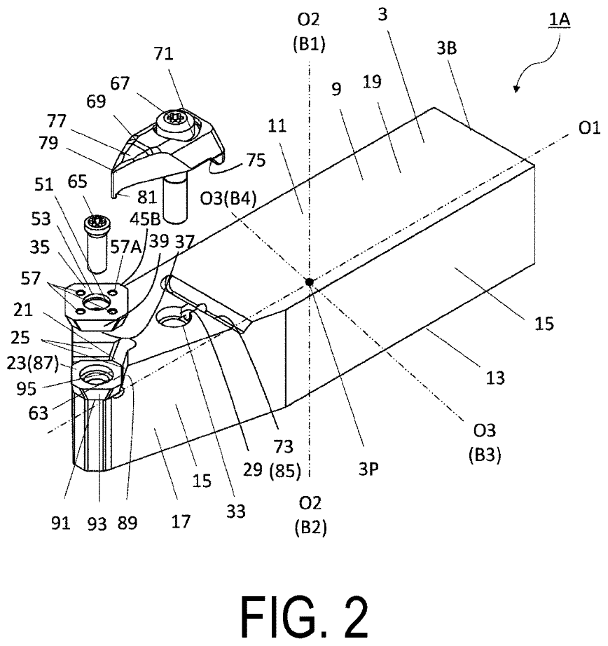

The pocket 21 may have a seat surface 23. In the holder 3 of the first embodiment, the seat surface 23 is a surface facing the same direction as the upper surface 11. The pocket 21 may have a restraint surface 25. The restraint surface 25 may be connected to the seat surface 23, and a groove may be provided between the seat surface 23 and the restraint surface 25 as in the example illustrated in FIG. 2. The seat surface 23 and the restraint surface 25 are surfaces with which the insert 5 is in contact. Note that when the holder 3 includes a sheet member 87 described later, a top side surface (first sheet surface 89) of the sheet member 87 functions as the seat surface 23. When the holder 3 does not include the sheet member 87, the seat surface 23 is located at the body portion 9.

The pocket 21 of the first embodiment has two restraint surfaces 25 facing the side of the first end 3A. The two restraint surfaces 25 may be connected to each other, and a groove may be provided between the restraint surfaces 25 as in the example illustrated in FIG. 2. The number of the restraint surfaces 25 is not limited.

The holder 3 (body portion 9) may include a first insertion port 27 and a second insertion port 29. In the cutting tool 1A of the first embodiment, any of the first insertion port 27 and the second insertion port 29 is a portion into which the fixture 7 is inserted. The first insertion port 27 may be connected to a first opening portion 31 located in the seat surface 23. In the holder 3 of the first embodiment, the first insertion port 27 extends from the first opening portion 31 toward the side of the lower surface 13. The first insertion port 27 may extend in a direction perpendicular to the reference axis O1 in a cross-section perpendicular to the seat surface 23.

The second insertion port 29 may be connected to a second opening portion 33 located in the upper surface 11. As illustrated in FIG. 2, the second opening portion 33 may be located on the side of the second end 3B from the first opening portion 31. In the holder 3 of the first embodiment, the second insertion port 29 extends from the second opening portion 33 toward the side of the lower surface 13. The second insertion port 29 may extend in a direction perpendicular to the reference axis O1 in a cross-section perpendicular to the upper surface 11.

The insert 5 may have a first surface 35, a second surface 37, and a third surface 39. The second surface 37 may be a surface located on an opposite side of the first surface 35, and the third surface 39 may be a surface located between the first surface 35 and the second surface 37. The insert 5 of the first embodiment has a first surface 35, a second surface 37, and a plurality of third surfaces 39.

The insert 5 may include a through hole 51 and a recessed portion 57 described later. The recessed portion 57 is located in the first surface 35. As illustrated in FIG. 2, in the present embodiment, since the recessed portion 57 is located in the top side surface of the insert 5, the “top side surface” of the insert 5 corresponds to the first surface 35. The bottom side surface of the insert 5 corresponds to the second surface 37 located on an opposite side of the first surface 35.

The first surface 35 in the present embodiment may include a rake face region 41, and the third surface 39 may include a flank face region 43. The shapes of the first surface 35, the second surface 37, and the third surface 39 are not limited but may be, for example, a quadrilateral shape.

Here, for convenience of description, an axis passing through a center 3P of the holder 3 and perpendicular to the reference axis O1 is referred to as a vertical axis O2, and in a direction in which the vertical axis O2 extends, a side on which the first surface 35 is located is referred to as a top side, and a side on which the second surface 37 is located is referred to as a bottom side. An axis extending in a direction perpendicular to the reference axis O1 and the vertical axis O2 is referred to as a left-right axis O3. In a front view of the first surface 35, a side on which the insert 5 is located with respect to the reference axis O1 is referred to as a right side, and an opposite side of the right side is referred to as a left side.

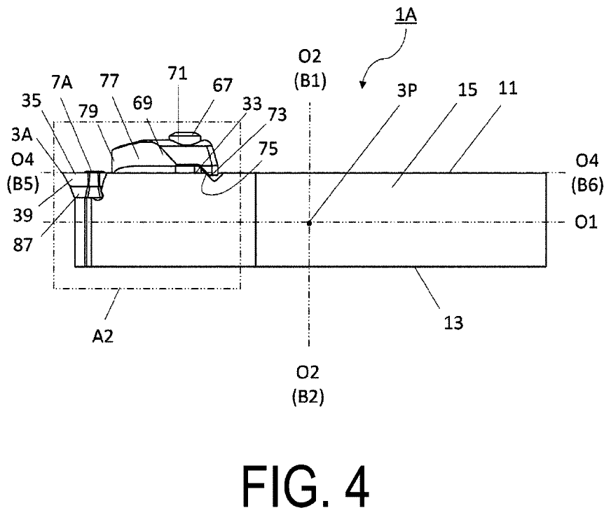

In the case where a center 5P of the insert 5 is located on the reference axis Ol in a front view of the first surface 35, as in the cutting tool 1A of the first embodiment, any one side may be referred to as a right side and the other side may be referred to as a left side. In the cutting tool 1A of the first embodiment, as illustrated in FIG. 4, the B1 direction is the top side, the B2 direction is the bottom side, the B3 direction is the right side, and the B4 direction is the left side. In the cutting tool 1A of the first embodiment, a straight line perpendicular to the first surface 35 is parallel to the vertical axis O2, the top side is synonymous with the side of the first surface 35, and the bottom side is synonymous with the side of the second surface 37.

Note that a front view of the first surface 35 refers to a case where the cutting tool 1A and the like are viewed from a direction perpendicular to the first surface 35. When the entire first surface 35 is not a flat surface and the direction perpendicular to the first surface 35 is not uniquely determined, the “direction perpendicular to the first surface 35” may be specified with reference to a flat surface having the largest area in the first surface 35. When defining a direction or a surface perpendicular to or parallel to a surface that is not entirely flat, a flat surface having the largest area in the surface may be used as a reference. The above description is not limited to the case where the surface is viewed from the front. The same applies to, for example, the case where the surface is viewed from a plane perspective.

The first surface 35 may include a corner 45 and a side 47 located at an intersection with the third surface 39. The first surface 35 or the third surface 39 may be expressed as including a corner 45 and a side 47, and the corner 45 and the side 47 may be described as being located on the first surface 35 or on the third surface 39. The corner 45 and the side 47 may be connected to each other. The insert 5 of the first embodiment includes four corners 45 and four sides 47.

Specifically, the first surface 35 includes a first corner 45A closest to the side of the first end 3A, a second corner 45B located closest to the center 3P of the holder 3, and a third corner 45C and a fourth corner 45D adjacent to the first corner 45A. “Located closest to the center 3P of the holder 3” means, in other words, located on the side of the second end 3B. Each of the third corner 45C and the fourth corner 45D may be adjacent to the second corner 45B. In FIG. 3, the third corner 45C is located on the right side, and the fourth corner 45D is located on the left side.

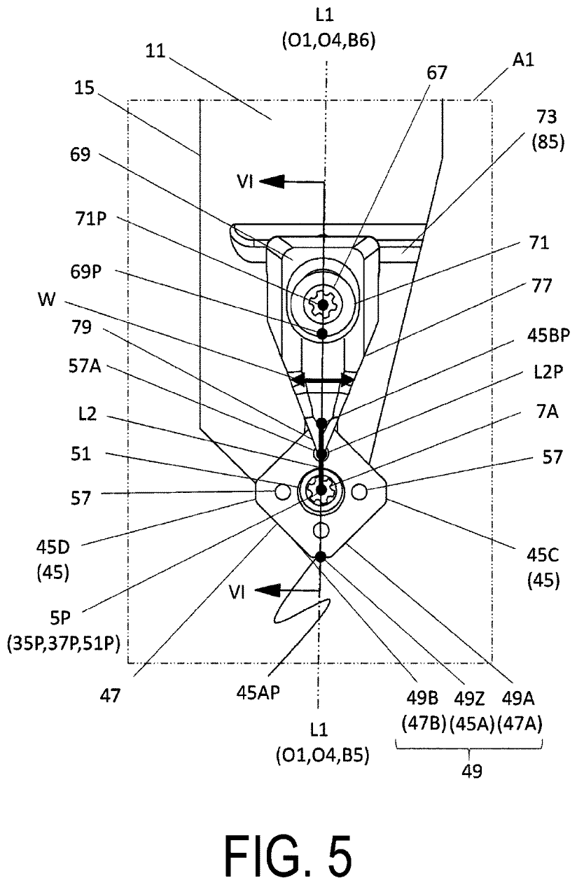

For convenience of description, as illustrated in FIG. 5, in a front-rear axis O4 passing through a center 35P of the first surface 35 and a center point 45BP of the second corner 45B, a side of the center 35P of the first surface 35 is referred to as a front side, and a side of the center point 45BP of the second corner 45B is referred to as a rear side. Note that since the center point 45BP of the second corner 45B is located on the bottom side of the second fixture 7B, FIG. 5 illustrates the position of the center point 45BP of the second corner 45B in a perspective of the second fixture 7B.

In the cutting tool 1A of the first embodiment, in a front view of the first surface 35, the reference axis O1 and the front-rear axis O4 coincide with each other. Therefore, the side of the first end 3A is synonymous with the front side, and the side of the second end 3B is synonymous with the rear side. Therefore, in the following description, when either of these synonymous terms is indicated, it shall be treated as also referring to the other. In FIG. 3, the B5 direction is referred to as the front side, and the B6 direction is referred to as the rear side.

The shapes of the corner 45 and the side 47 are not limited. However, for example, in a front view of the first surface 35, each corner 45 may have a curved shape and each side 47 may have a linear shape. The linear shape does not need to be a microscopically linear shape but may be a macroscopically linear shape. The curved shape may be, for example, an arc shape with a constant radius of curvature.

The insert 5 may include a cutting edge 49. The cutting edge 49 may be located on the corner 45 and/or on the side 47. The insert 5 of the first embodiment includes a first corner 45A located on the side of the first end 3A, and a first side 47A and a second side 47B connected to the first corner 45A. The insert 5 of the first embodiment includes a first cutting edge 49A located on the first side 47A, a second cutting edge 49B located on the second side 47B, and a corner cutting edge 49Z located on the first corner 45A. The corner cutting edge 49Z may be connected to each of the first cutting edge 49A and the second cutting edge 49B.

The insert 5 may include a through hole 51. In the insert 5 of the first embodiment, the through hole 51 penetrates from a first port 53 located on the first surface 35 to a second port 55 located on the second surface 37. In the insert 5 of the first embodiment, the first port 53 is located at the center 35P of the first surface 35, and the second port 55 is located at a center 37P of the second surface 37. A central axis of the through hole 51 passes through the center 35P of the first surface 35 and the center 37P of the second surface 37.

Note that the insert 5 is not limited to the flat-type insert 5 as illustrated in the first embodiment, and may be, for example, a vertical-type insert 5. In the case of the vertical-type insert 5, one of the left and right surfaces of the third surface 39 may include the rake face region 41, and a surface of the third surface 39 located on the side of the first end 3A may include the flank face region 43. In this case, the insert 5 includes the cutting edge 49 located on the corner 45 and/or on the side 47 located between the surface including the rake face region 41 and the surface including the flank face region 43.

The insert 5 may include a recessed portion 57. As will be described later, the recessed portion 57 is a portion with which the fixture 7 comes into contact. The recessed portion 57 may be separated from the through hole 51. The number of recessed portions 57 is not limited. One or more recessed portions 57 may be provided on at least one of the first surface 35 and the second surface 37. In the insert 5 of the first embodiment, the number of recessed portions 57 is four on the first surface 35. The shape of the recessed portion 57 is not limited. For example, the recessed portion 57 may be a through hole, a blind hole that does not penetrate, or a tapered shape that tapers from the first surface 35 toward the second surface 37.

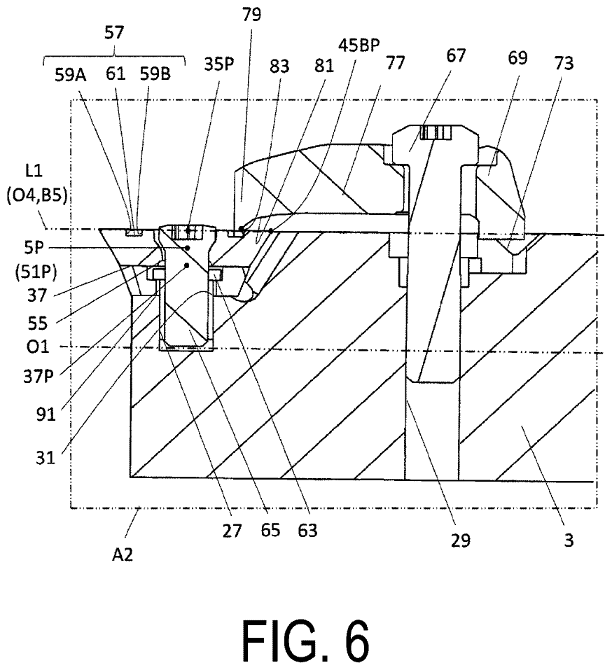

The recessed portion 57 may include a peripheral wall portion 59. Since the recessed portion 57 of the first embodiment is a blind hole, it may include a bottom portion 61 connected to the peripheral wall portion 59. The bottom portion 61 may face the top side. The shapes of the peripheral wall portion 59 and the bottom portion 61 are not limited. However, for example, the peripheral wall portion 59 may have a curved surface shape, and the bottom portion 61 may have a planar shape. The peripheral wall portion 59 may include a first peripheral wall portion 59A located on the front side and a second peripheral wall portion 59B located on the rear side in a cross-sectional view as in the example illustrated in FIG. 6.

The cutting tool 1A may include a first fixture 7A and a second fixture 7B as the fixture 7. It may be expressed that the fixture 7 includes a first fixture 7A and a second fixture 7B. The first fixture 7A is a fixture 7 for fixing the insert 5 to the body portion 9, and the second fixture 7B is a fixture 7 for positioning the insert 5 by applying a force to the insert 5 toward the rear side.

Here, in the cutting tool 1A of the first embodiment, the second fixture 7B can apply a force to the insert 5 in a direction toward the rear side. More particularly, the second fixture 7B can apply a force to the insert 5 in a direction extending along the reference axis O1 toward the side of the second end 3B corresponding to the rear side.

Here, FIG. 6 is an enlarged view corresponding to region A2 illustrated in FIG. 4, in a VI-VI cross-section. The VI-VI cross-section is a cross-section passing through the center 35P of the first surface 35, the center 37P of the second surface 37, and a center 69P of a clamp 69 corresponding to a center 7BP of the second fixture 7B. Note that the VI-VI cross-section is also a cross-section including the center point 45AP of the first corner 45A, the center point 45BP of the second corner 45B, and the center 5P of the insert 5, and passing through the central axes of the first fixture 7A, the through hole 51, and the second fixture 7B. The VI-VI cross-section is parallel to the reference axis O1 and is parallel to a virtual straight line L1 extending in a direction in which the second fixture 7B applies a force to the insert 5.

In the cutting tool 1A of the first embodiment, the first fixture 7A is inserted into the through hole 51 and the first insertion port 27 from the top side toward the bottom side. The second fixture 7B is inserted into the second insertion port 29 from the top side toward the bottom side. As illustrated in FIG. 6, the first fixture 7A and the second fixture 7B extend perpendicularly to the reference axis O1.

Although the first fixture 7A and the second fixture 7B are not limited, in the fixture 7 of the first embodiment, the first fixture 7A includes a first screw 63 and a clamp bolt 65, and the second fixture 7B includes a second screw 67 and a clamp 69. The first screw 63 may have a hollow inside. The clamp 69 may include a clamp through hole 71 into which the second screw 67 is inserted. The second screw 67 may be inserted into the clamp through hole 71 and the second insertion port 29.

For example, the first fixture 7A may be configured by only the first screw 63. The second fixture 7B may be, for example, a member in which the clamp 69 and the second screw 67 are integrally formed. When the first fixture 7A can fix the insert 5 to the body portion 9 without being inserted into the through hole 51 and the first insertion port 27, the insert 5 does not need to include the through hole 51, and the body portion 9 does not need to include the first insertion port 27. The body portion 9 does not necessarily need to include the second insertion port 29.

The upper surface 11 may have an inclined surface 73 that approaches the lower surface 13 from the front side toward the rear side. In such a case, for example, when the second screw 67 is tightened, the clamp 69 moves toward the bottom side and the rear side along the inclined surface 73 with which the clamp 69 is in contact. Even in the case where the clamp 69 includes a clamp inclined surface 75 that approaches the lower surface 13 from the front side toward the rear side, the clamp 69 can similarly move toward the bottom side and the rear side. In the cutting tool 1A of the first embodiment, the inclined surface 73 may be located on the rear side from the second opening portion 33, and the clamp inclined surface 75 may be located on the lower side and the rear side from the clamp through hole 71.

The clamp 69 may include an arm portion 77. The arm portion 77 extends from the rear side toward the front side. As illustrated in FIG. 5, in a front view of the first surface 35, a width W of the arm portion 77 in the left-right direction decreases from the rear side toward the front side. In the cutting tool 1A of the first embodiment, the arm portion 77 is located on the front side with respect to a center 71P of the clamp through hole 71.

The arm portion 77 may be engaged with the recessed portion 57. Here, the recessed portion 57 engaged with the arm portion 77 is hereinafter referred to as a first recessed portion 57A in order to distinguish it from the other recessed portions 57. The arm portion 77 may include an engaging portion 79. The engaging portion 79 may overlap the first surface 35 when the first surface 35 is viewed from a plane perspective. Whether objects overlap each other when the first surface 35 is viewed from a plane perspective may be determined, for example, based on whether the objects are arranged in a direction perpendicular to the first surface 35 in a cross-section perpendicular to the first surface 35 as illustrated in FIG. 6. The cutting tool 1A of the first embodiment includes an end portion on the bottom side of the arm portion 77 and an end portion on the front side of the arm portion 77. The engaging portion 79 may be engaged with the first recessed portion 57A or may be in contact with the second peripheral wall portion 59B of the first recessed portion 57A.

In the cutting tool 1A of the first embodiment, the clamp 69 is moved toward the bottom side and the rear side by tightening the second screw 67. The clamp 69 applies a force to the insert 5 toward the side of the holder 3, thereby positioning the insert 5. By fixing the positioned insert 5 with the clamp bolt 65, the insert 5 can be fixed to the pocket 21 to such an extent that the insert 5 can be used for machining.

Note that when positioning the insert 5, it is not necessary for the insert 5 to actually move to the rear side, and even if the insert 5 does not move, the insert 5 may be in a state in which it does not move by the force applied to the insert 5 by the clamp 69. Here, the not-moving state refers to a state in which the insert 5 is fixed to such an extent that the insert 5 does not move due to contact with a human hand or the like which may occur during normal replacement work of the insert 5, for example. At the time of fixing by the first fixture 7A, the insert 5 may slightly move toward the bottom side from the positioned position.

As described above, the fixing by the first fixture 7A means that the insert 5 is fixed to the holder 3 to such an extent that the insert 5 can be used for machining. On the other hand, the fixing by the second fixture 7B is merely fixing for positioning the insert 5, and it is not necessary to fix the insert 5 to the holder 3 to such an extent that the insert 5 can be used for machining. Hereinafter, fixing by the first fixture 7A is referred to as “fixing”, and fixing by the second fixture 7B is referred to as “positioning”.

As described above, the cutting tool 1A of the first embodiment can first position the insert 5 by the second fixture 7B and then fix the insert 5 by the first fixture 7A. As a result, it is possible to suppress the occurrence of an attachment error of the insert 5, such as the insert 5 being fixed to the body portion 9 while inclined with respect to the seat surface 23. This contributes to a reduction in the risk of an accident occurring due to machining in a state where the insert 5 is not correctly attached, an improvement in work efficiency, and the like.

The first recessed portion 57A may be located on the rear side from the center 5P of the insert 5. The first recessed portion 57A may be located on the side of the second end 3B from the center 5P of the insert 5. In such a case, since the first recessed portion 57A is relatively close to the center 3P of the holder 3, the force applied from the second fixture 7B to the insert 5 is stabilized, and the accuracy of positioning the insert 5 is further enhanced.

In a front view of the first surface 35, when a line segment connecting the central axis of the through hole 51 corresponding to the center 5P of the insert 5 and the center point of the corner 45 is set as a virtual line segment L2, the first recessed portion 57A may be positioned on the virtual line segment L2. In the cutting tool 1A of the first embodiment, the virtual line segment L2 connecting the center 5P of the insert 5 and the center point 45BP of the second corner 45B overlaps the first recessed portion 57A.

The first recessed portion 57A may be located at a center point L2P of the virtual line segment L2. As illustrated in FIG. 5, in the cutting tool 1A of the first embodiment, the center point L2P of the virtual line segment L2 connecting the center 5P of the insert 5 and the center point 45BP of the second corner 45B overlaps the first recessed portion 57A. In such a case, it is possible to increase the accuracy of positioning the insert 5 while suppressing the risk of a decrease in the durability of the insert 5.

When the first surface 35 is viewed from a plane perspective, the first fixture 7A may be separated from the second fixture 7B. In such a case, since the risk of the second fixture 7B becoming an obstacle when inserting the first fixture 7A is reduced, the fixing of the insert 5 by the first fixture 7A can be performed more efficiently. In the cutting tool 1A of the first embodiment, at least part of the second fixture 7B is located above the first fixture 7A, the first fixture 7A is separated from the second fixture 7B in a front view of the first surface 35. When the first surface 35 is viewed from a plane perspective, the through hole 51 may be separated from the second fixture 7B.

The engaging portion 79 may be in contact with the second peripheral wall portion 59B. The engaging portion 79 may be separated from the bottom portion 61. In a case where the engaging portion 79 is separated from the bottom portion 61, when a force is applied to the insert 5 from the second fixture 7B, generation of a friction force between the engaging portion 79 and the bottom portion 61 can be suppressed, and thus the positioning of the insert 5 can be performed more efficiently. In addition, when the engaging portion 79 is separated from the bottom portion 61, a risk that the engaging portion 79 receives an upward force from the insert 5 at the time of cutting can be reduced, and the durability of the second fixture 7B is further enhanced.

The engaging portion 79 may include a depression 81 having a recessed shape toward the side of the front end. The depression 81 may have a recessed shape toward the side of the first end 3A. An end portion on the bottom side of the depression 81 may be in contact with the second peripheral wall portion 59B. A bottom 83 of the depression 81 may be located on the front side or the side of the first end 3A from at least part of the first recessed portion 57A. The bottom 83 of the depression 81 may be a point region, as illustrated in FIG. 6. It may be located above the recessed portion 57. The bottom 83 of the depression 81 may be located above the recessed portion 57.

In the case where the bottom 83 of the depression 81 is located on the front side or the side of the first end 3A from at least part of the first recessed portion 57A, even if the second fixture 7B is slightly inclined clockwise when the cutting tool 1A is viewed from a right side as illustrated in FIG. 6 before the positioning of the insert 5 by the second fixture 7B, when the second fixture 7B is moved toward the bottom side and the side of the second end 3B, a force can be more efficiently applied from the second fixture 7B to the insert 5 toward the rear side.

The direction of the force applied from the second fixture 7B to the insert 5 and the virtual line segment L2 connecting the first recessed portion 57A and the corner 45 may be parallel. Here, “parallel” does not need to be strictly parallel and is treated as parallel when an angle θ formed by the direction of the force applied to the insert 5 by the second fixture 7B and the virtual line segment L2 connecting the recessed portion 57 and the corner 45 is within a range −2°≤θ≤+2°. In such a case, the two third surfaces 39 positioned in the vicinity of the corner 45 are more likely to guide the insert 5 by the restraint surface 25, and thus the accuracy of positioning the insert 5 is further enhanced. It can be said that the same applies to a case where the direction in which the arm portion 77 extends and the virtual line segment L2 are parallel to each other.

In the insert 5 of the first embodiment, since the clamp 69 pulls the insert 5 in a direction perpendicular to a strip-shaped region 85 formed by extending the inclined surface 73, the direction in which the strip-shaped region 85 extends may be perpendicular to the front-rear axis O4, or the direction in which the strip-shaped region 85 extends may be perpendicular to the virtual line segment L2. When the first surface 35 is viewed from a plane perspective, the second screw 67, the recessed portion 57, and the center 5P of the insert 5 may be aligned in a straight line.

The holder 3 may include a sheet member 87 in addition to the body portion 9. The sheet member 87 may be located between the body portion 9 and the insert 5. In such a case, it is possible to reduce the possibility that the body portion 9 will be damaged when the insert 5 is broken.

The sheet member 87 has a first sheet surface 89, a second sheet surface 91, and a third sheet surface 93. The sheet member 87 of the first embodiment includes a first sheet surface 89, a second sheet surface 91, and a plurality of third sheet surfaces 93. The shapes of the first sheet surface 89, the second sheet surface 91, and the third sheet surface 93 are not limited, but may be, for example, a quadrilateral shape.

The first sheet surface 89 is in contact with the bottom side surface (second surface 37) of the insert 5. In the example illustrated in FIG. 1, the first sheet surface 89 faces the same top side direction as the top side surface (first surface 35) of the insert 5. The second sheet surface 91 may be located on an opposite side of the first sheet surface 89. The second sheet surface 91 may be in contact with the body portion 9. The second sheet surface 91 may face the same bottom side direction as the bottom side surface (second surface 37) of the insert 5. The pocket 21 may be constituted by the body portion 9 and the sheet member 87.

The third sheet surface 93 is a surface connected to the first sheet surface 89 and the second sheet surface 91. The first sheet surface 89 and the second sheet surface 91 are positioned on a pair of main surfaces of the sheet member 87, and the third sheet surface 93 is positioned on a side surface of the sheet member 87. The sheet member 87 is not limited to a thin plate shape conforming to the general concept of a sheet, but may be a thick plate shape having a large width in the direction along the vertical axis O2 of the third sheet surface 93 as in the non-limiting example illustrated in FIG. 2.

The sheet member 87 may include a sheet through hole 95 penetrating through the first sheet surface 89 and the second sheet surface 91. In the cutting tool 1A of the first embodiment, the sheet through hole 95 penetrates through the center of the first sheet surface 89 and the center of the second sheet surface 91. The sheet through hole 95 may be aligned with the first insertion port 27 and the through hole 51 in the direction in which the reference axis O1 extends.

In the cutting tool 1A of the first embodiment, when fixing the insert 5 to the holder 3 by the first fixture 7A, the sheet member 87 is first positioned on the body portion 9.

Specifically, the first screw 63 of the first fixture 7A is inserted into the sheet through hole 95. The insert 5 is positioned on the first sheet surface 89. After the above-described positioning of the insert 5 is performed, the insert 5 can be fixed to the holder 3 by inserting the clamp bolt 65 included in the first fixture 7A into the through hole 51 and the sheet through hole 95 (first screw 63).

Examples of a material of the body portion 9 include steel, cast iron, and an aluminum alloy. A size of the body portion 9 can be set to, for example, the following values. A dimension of the body portion 9 in the direction in which the reference axis O1 extends is, for example, 32 to 500 mm. A dimension of the body portion 9 in the vertical direction is, for example, 10 to 50 mm. A dimension of the body portion 9 in the left-right direction is, for example, 10 to 50 mm.

Examples of a material of the insert 5 include a cemented carbide alloy and a cermet. Examples of the cemented carbide alloy include WC-Co, WC-TiC-Co, and WC-TiC-TaC-Co. WC-Co is produced by adding cobalt (Co) powder to tungsten carbide (WC) and sintering them. WC-TiC-Co is formed by adding titanium carbide (TiC) to WC-Co. WC-TiC-TaC-Co is formed by adding tantalum carbide (TaC) to WC-TiC-Co. Cermet is a sintered composite material in which a metal is combined with a ceramic component. Examples of the cermet include compounds in which a titanium compound such as titanium carbide (TiC) or titanium nitride (TiN) is the primary component.

The surface of the insert 5 may be coated with a coating film. Examples of composition of the coating film include titanium carbide (TiC), titanium nitride (TiN), titanium carbonitride (TiCN), and alumina (Al₂O3). Examples of the film formation method of the coating film include a chemical vapor deposition (CVD) method and a physical vapor deposition (PVD) method.

A size of the insert 5 can be set to, for example, the following values. A length of one side 47 of the quadrilateral shape on the upper surface 11 and the lower surface 13 is, for example, 3 to 54 mm. A thickness of the insert 5 from the upper surface 11 to the lower surface 13 is, for example, 2 to 10 mm.

The insert 5 may be either a positive type or a negative type. In the case of the insert 5 in which the first surface 35 and the second surface 37 have the same shape, by providing both the first surface 35 and the second surface 37 with the recessed portion 57, the positioning of the insert 5 described above can be utilized even when the insert 5 is used for machining with the first surface 35 and the second surface 37 oriented opposite to each other.

The recessed portion 57 positioned on the first surface 35 and the recessed portion 57 positioned on the second surface 37 may be positioned point-symmetrically with respect to the center 5P of the insert 5. In such a case, when the first surface 35 and the second surface 37 are oriented opposite to each other and the insert 5 is mounted to the body portion 9, the positioning of the insert 5 can be performed without changing the position and the like of the second fixture 7B.

Examples of a material of the screw include SCM440. Examples of a material of the clamp 69 include SCM440. Examples of a material of the sheet member 87 include a cemented carbide alloy.

### Second Embodiment

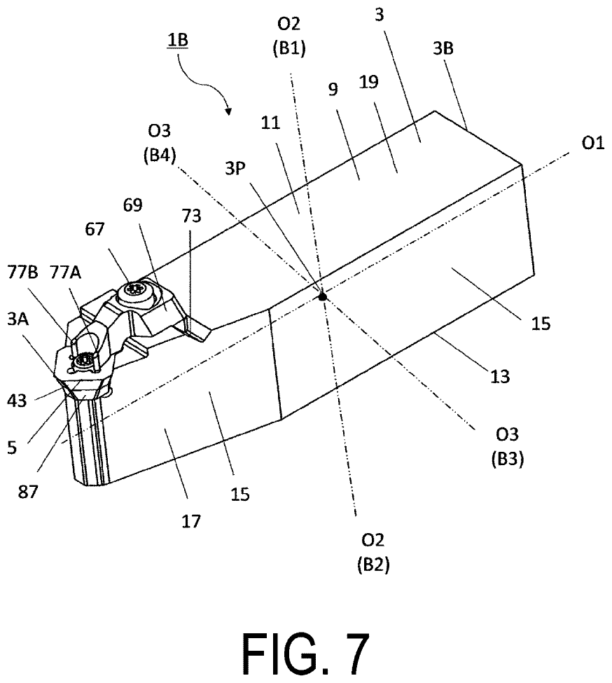

A cutting tool 1B according to a second embodiment of the present disclosure will be described in detail with reference to FIGS. 7 to 9. Note that the following description will focus on parts that differ from the first embodiment. Thus, unless otherwise specified, for components similar to the corresponding components of the first embodiment, the description in the first embodiment is incorporated in the second embodiment by reference, and description of these components is omitted.

In the insert 5 of the second embodiment, similarly to the insert 5 of the first embodiment, since the recessed portion 57 is located in the top side surface of the insert 5, the “top side surface” of the insert 5 corresponds to the first surface 35. The bottom side surface of the insert 5 corresponds to the second surface 37 located on an opposite side of the first surface 35.

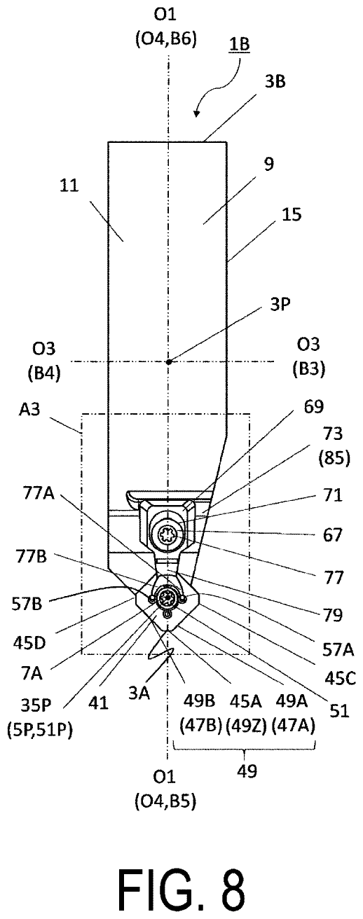

In the cutting tool 1B of the second embodiment, the arm portion 77 includes a first arm portion 77A and a second arm portion 77B. The first arm portion 77A and the second arm portion 77B have a shape divided into two on the front side of the arm portion 77. In a front view of the first surface 35, the first arm portion 77A and the second arm portion 77B are line-symmetric to each other with respect to a virtual straight line L3 passing through a branch point 77P of the first arm portion 77A and the second arm portion 77B and the center 69P of the clamp 69. Note that when the position of the branch point is not uniquely determined, a straight line passing through the center 69P of the clamp 69 and parallel to the direction of the force applied from the second fixture 7B to the insert 5 may be set as the virtual straight line L3. As illustrated in FIG. 8, the first arm portion 77A may be positioned on the right side and the second arm portion 77B may be positioned on the left side with respect to the reference axis O1.

The first surface 35 may include a first recessed portion 57A and a second recessed portion 57B. The first arm portion 77A is engaged with the first recessed portion 57A, and the second arm portion 77B is engaged with the second recessed portion 57B. In such a case, since the arm portion 77 is engaged with the plurality of recessed portions 57, the second fixture 7B can more stably apply a force to the insert 5, and as a result, the accuracy of positioning the insert 5 is further enhanced.

Here, the position of the first recessed portion 57A in the second embodiment is different from the position of the first recessed portion 57A in the first embodiment. Specifically, in the cutting tool 1B of the second embodiment, the insert 5 includes a third corner 45C and a fourth corner 45D adjacent to the first corner 45A, the first recessed portion 57A is located between the center 5P of the insert 5 and a center point 45CP of the third corner 45C, and the second recessed portion 57B is located between the center 5P of the insert 5 and a center point 45CP of the fourth corner 45D. The first recessed portion 57A and the second recessed portion 57B may each be located on a straight line perpendicular to the front-rear axis O4 and passing through the center point of the insert 5.

In a front view of the first surface 35, the through hole 51 may be located between the first recessed portion 57A and the second recessed portion 57B. In such a case, since the force is uniformly applied to the insert 5 from the first arm portion 77A engaged with the first recessed portion 57A and the second arm portion 77B engaged with the second recessed portion 57B, the accuracy of positioning the insert 5 is further enhanced.

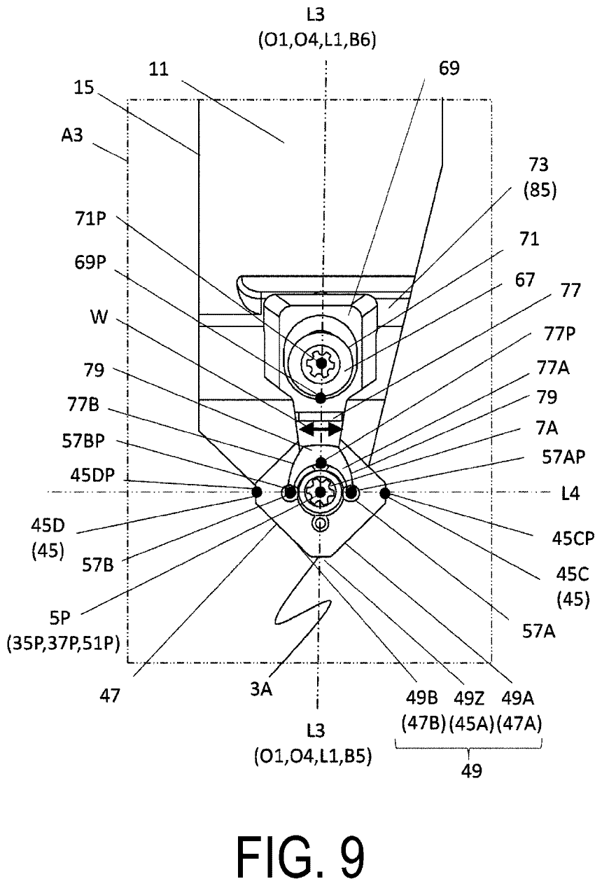

When the center 51P of the through hole 51 is located on a virtual straight line LA passing through a center 57AP of the first recessed portion 57A and a center 57BP of the second recessed portion 57B in a front view of the first surface 35, the force is more uniformly applied to the insert 5 from the first arm portion 77A and the second arm portion 77B, and thus the accuracy of positioning the insert 5 is further enhanced. Note that in FIG. 9, the virtual straight line LA is perpendicular to the virtual straight line L3.

In a front view of the first surface 35, any of the widths of the first arm portion 77A and the second arm portion 77B in the left-right direction may decrease toward the front side.

### Third Embodiment

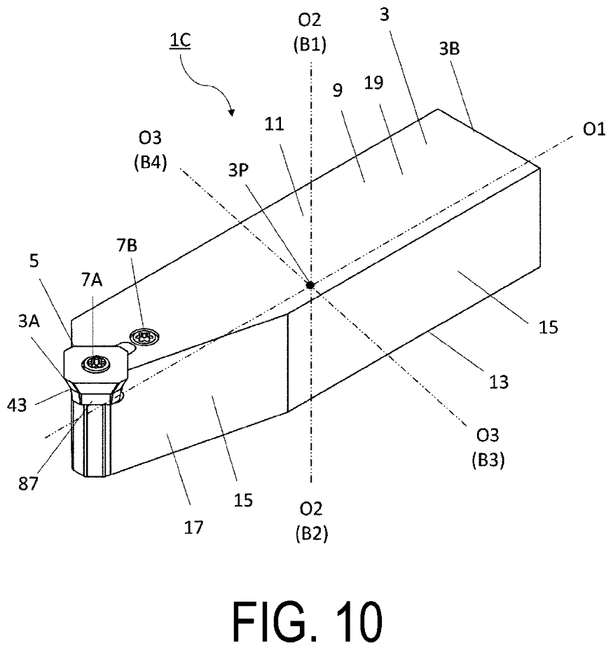

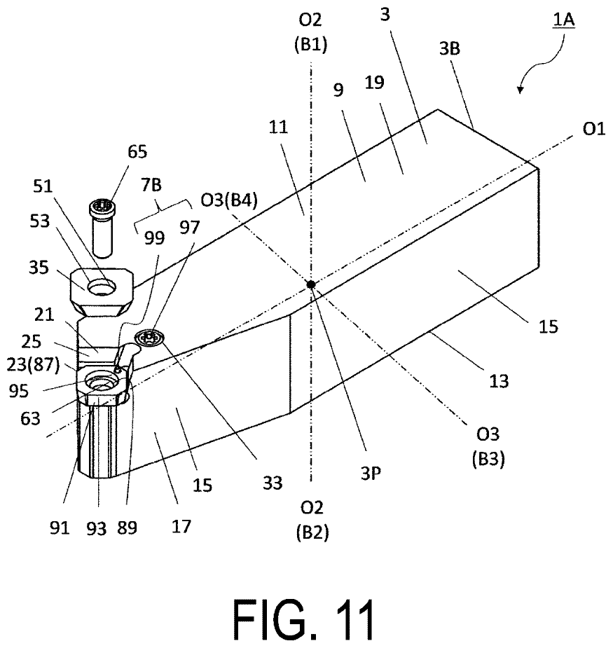

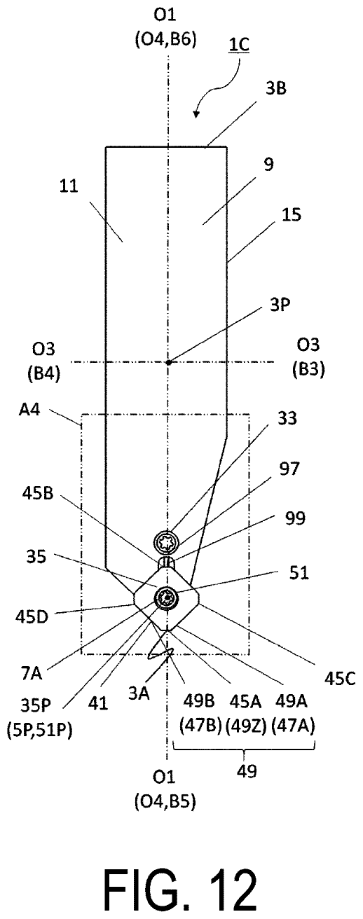

A cutting tool 1C according to a third embodiment of the present disclosure will be described in detail with reference to FIGS. 10 to 15. Note that the following description will focus on parts that differ from the first embodiment. Thus, unless otherwise specified, for components similar to the corresponding components of the first embodiment, the description in the first embodiment is incorporated in the second embodiment by reference, and description of these components is omitted.

The insert 5 of the second embodiment is different from the inserts 5 of the first and second embodiments, and the recessed portion 57 is located in the bottom side surface of the insert 5. Therefore, in the present embodiment, the “bottom side surface” of the insert 5 corresponds to the first surface 35. The top side surface of the insert 5 corresponds to the second surface 37 located on an opposite side of the first surface 35.

Therefore, in the direction in which the vertical axis O2 extends, a side on which the second surface 37 is located is referred to as a top side, and a side on which the first surface 35 is located is referred to as a bottom side. In a front view of the first surface 35, a side on which the insert 5 is positioned with respect to the reference axis O1 is referred to as a left side, and a side opposite to the left side is referred to as a right side.

In the inserts 5 of the first embodiment and the second embodiment, the cutting edge 49 is located at the intersection of the first surface 35 and the third surface 39, but in the insert 5 of the present embodiment, the cutting edge 49 is located at the intersection of the second surface 37 and the third surface 39.

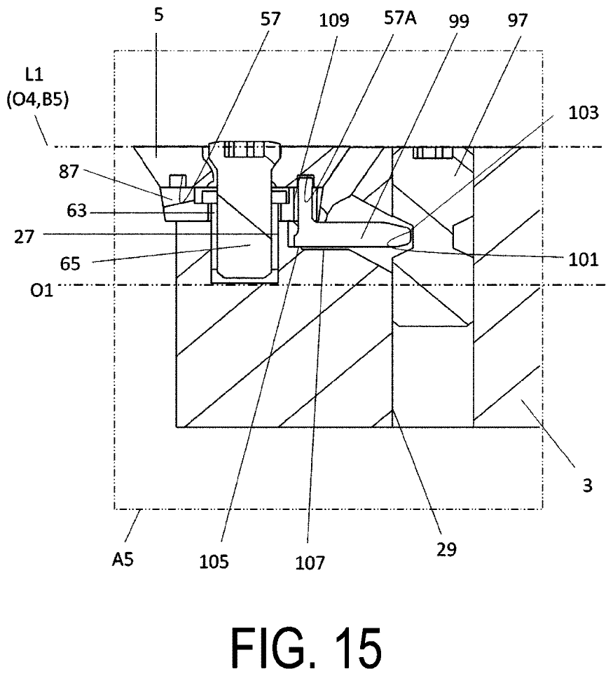

In the cutting tool 1C of the third embodiment, the second fixture 7B includes a clamp screw 97 and a pull-in member 99. The clamp screw 97 may have a first contact surface 101 facing the bottom side and the pull-in member 99 may have a second contact surface 103 that faces the top side and is in contact with the first contact surface 101. The pull-in member 99 may be an L-shaped member, and has an L-shape in the XV-XV cross-section illustrated in FIG. 15. The pull-in member 99 corresponds to the arm portion 77 in the first embodiment, and may be a member that applies a force to move the insert 5 toward the rear side.

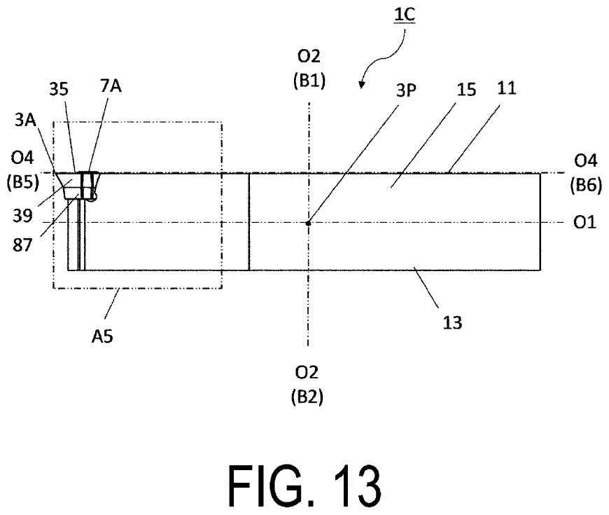

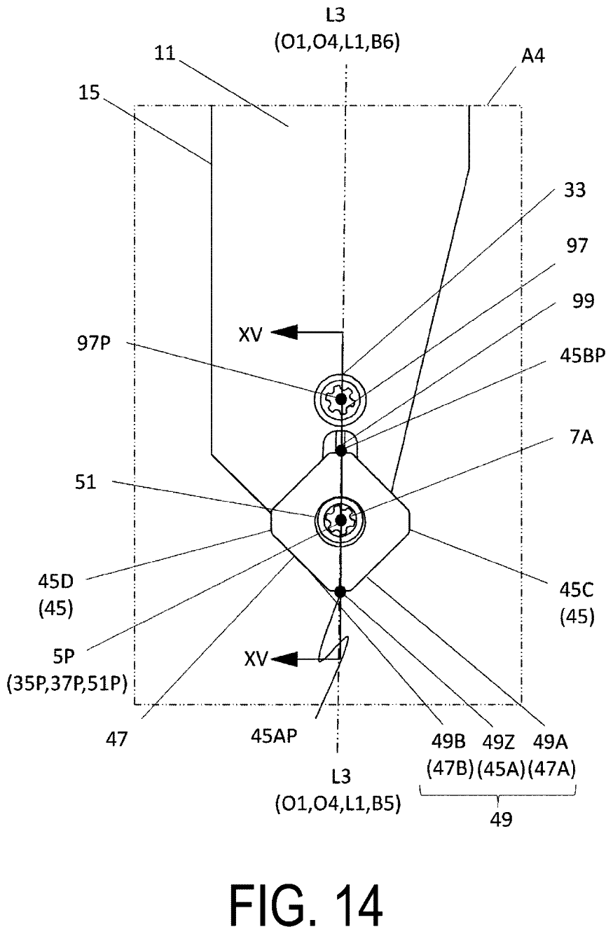

Here, FIG. 15 is an enlarged view corresponding to region A5 illustrated in FIG. 13, in a XV-XV cross-section in FIG. 14. The XV-XV cross-section is a cross-section passing through the center 35P of the first surface 35, the center 37P of the second surface 37, and a center 97P of the clamp screw 97 corresponding to the center 7BP of the second fixture 7B. Note that the XV-XV cross-section is also a cross-section including the center point 45AP of the first corner 45A, the center point 45BP of the second corner 45B, and the center 5P of the insert 5 and passing through the central axes of the first fixture 7A, the second fixture 7B, the through hole 51, and the clamp screw 97. The XV-XV cross section is parallel to the reference axis O1 and is parallel to a straight line extending in a direction in which the second fixture 7B pulls the insert 5.

In the cutting tool 1C of the third embodiment, the pull-in member 99 is engaged with the recessed portion 57 (first recessed portion 57A). In the cutting tool 1C of the third embodiment, the clamp screw 97 is moved toward the bottom side by tightening the clamp screw 97, whereby a force is applied from the first contact surface 101 to the second contact surface 103 toward the bottom side.

Since the front side portion (first portion 105) is in contact with the body portion 9 and the rear side portion (second portion 107) is away from the body portion 9 on the bottom side, when a force is applied from the first contact surface 101 to the second contact surface 103 toward the bottom side at a position further away from the center 5P of the insert 5 than the first portion 105, the pull-in member 99 rotates clockwise in the cross-section illustrated in FIG. 15, with the first portion 105 as a fulcrum. As a result, the pull-in member 99 can apply a force in a direction in which the insert 5 is moved toward the rear side in the recessed portion 57, and can position the insert 5.

Since the second surface 37 faces the seat surface 23 of the holder 3, at least part of the second fixture 57A engaging with the first recessed portion 7B located in the second surface 37 may be located inside the holder 3. In such a case, the risk of chips or the like colliding with the second fixture 7B is reduced, and the durability of the second fixture 7B is enhanced. In the cutting tool 1C of the third embodiment, the entire second fixture 7B is located inside the holder 3.

The sheet member 87 may include a sheet hole 109 extending through the first sheet surface 89 and the second sheet surface 91. As illustrated in FIG. 15, the sheet hole 109 is aligned with the recessed portion 57 in the direction in which the vertical axis O2 extends. The second fixture 7B includes the pull-in member 99 that passes through the sheet hole 109 and engages with the recessed portion 57.

Note that it is not necessary to provide the sheet member 87 in the cutting tool 1C of the third embodiment. However, when the sheet member 87 is provided, there may be a clearance between the pull-in member 99 and the sheet hole 109. If there is a clearance, a rearward force can be applied to the insert 5 without moving the sheet member 87.

### Method for Manufacturing Machined Product

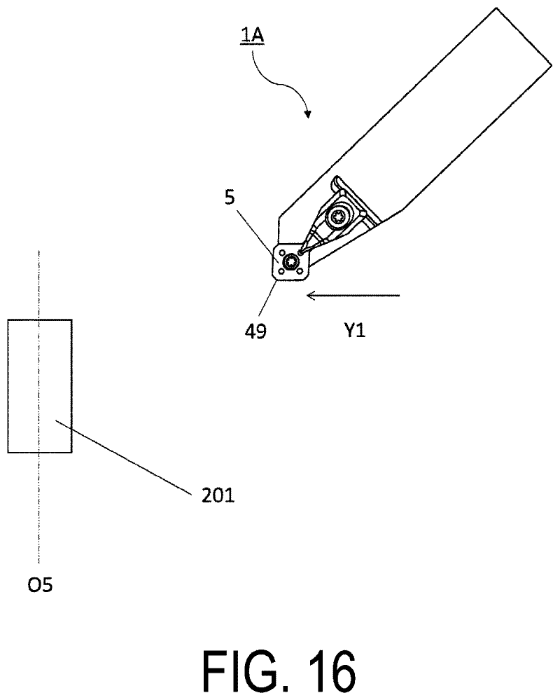

A method for manufacturing a machined product according to a non-limiting embodiment will be described. Note that in the example illustrated in FIGS. 16 to 18, the cutting tool 1A according to the first embodiment, which is not limited to the above, is used. For example, the cutting tools 1A according to the second embodiment and the third embodiment may be used without any problem.

The method for manufacturing a machined product according to an embodiment includes the following steps (C1) to (C3):
(C1) rotating a workpiece 201,
(2) bringing the cutting tool 1A into contact with the workpiece 201 that is rotating, and
(3) separating the cutting tool 1A from the workpiece 201.

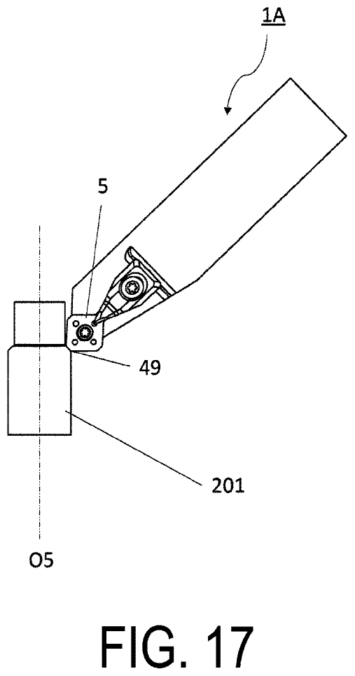

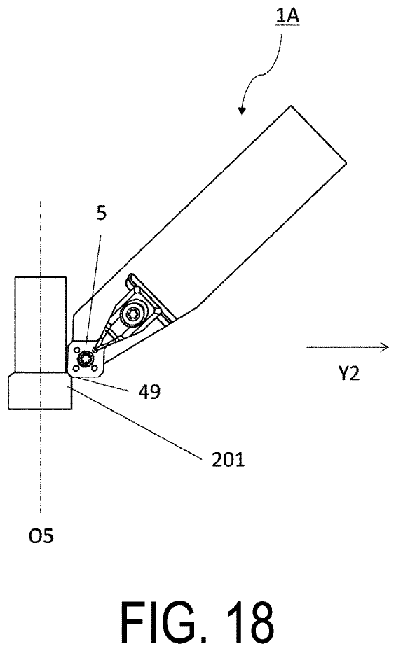

More specifically, first, as illustrated in FIG. 16, the workpiece 201 is rotated about a rotation axis O5, and the cutting tool 1A is relatively brought close to the workpiece 201. As illustrated in FIG. 17, the cutting edge 49 of the cutting tool 1A is brought into contact with the workpiece 201 that is rotating, and the workpiece 201 is cut. As illustrated in FIG. 18, the cutting tool 1A is relatively kept away from the workpiece 201.

In the embodiment, the cutting tool 1A is brought close to the workpiece 201 by moving the cutting tool 1A in a Y1 direction in a state where the workpiece 201 is rotating about the rotation axis O5. In FIG. 17, the workpiece 201 is cut by bringing the cutting edge 49 of the insert 5 into contact with the workpiece 201 that is rotating. In FIG. 18, moving the cutting tool 1A in a Y2 direction while rotating the workpiece 201 keeps the cutting tool 1A away from the workpiece 201.

Note that, in the machining of the manufacturing method of the embodiment, in each of the respective steps, although the cutting tool 1A is brought into contact with or separated from the workpiece 201 by moving the cutting tool 1A, the embodiment is of course not limited to such a mode.

For example, in step (C1), the workpiece 201 may be brought close to the cutting tool 1A. Similarly, in step (C3), the workpiece 201 may be kept away from the cutting tool 1A. When the machining is to be continued, steps of bringing the cutting edge 49 of the insert 5 into contact with different places on the workpiece 201 may be repeated while maintaining the rotating state of the workpiece 201.

Note that examples of the material of the workpiece 201 include carbon steel, alloy steel, stainless steel, cast iron, and non-ferrous metal.

In an embodiment, (1) a cutting tool extending from a front end toward a rear end along a reference axis may include: a holder including a pocket located on a side of the front end; an insert to be attached to the pocket; and a plurality of fixtures for fixing the insert to the pocket. The insert has a first surface and a second surface located on an opposite side of the first surface and includes a through hole opening in the first surface and the second surface and a first recessed portion located in the first surface. The plurality of fixtures include a first fixture inserted into the through hole and a second fixture engaged with the first recessed portion.

(2) In the cutting tool according to the above (1), the recessed portion may be located on a side of the rear end from a center of the insert.

(3) In the cutting tool according to the above (2), the first surface may include a corner located on the side of the rear end, and in a front view of the first surface, the first recessed portion may be located on a virtual line segment connecting a central axis of the through hole and a center point of the corner.

(4) In the cutting tool according to any one of the above (1) to (3), in a front view of the first surface, the first fixture may be located separated from the second fixture.

(5) In the cutting tool according to any one of the above (1) to (4), the first recessed portion may include a bottom portion and a peripheral wall portion connected to the bottom portion, and the second fixture may be in contact with the peripheral wall portion and may be separated from the bottom portion.

(6) In the cutting tool according to any one of the above (1) to (5), the second fixture may include an engaging portion overlapping the first surface when the first surface is viewed from a plane perspective, the engaging portion may include a depression having a recessed shape toward the side of the front end, and a bottom of the depression may be located on the side of the front end from at least part of the first recessed portion.

(7) In the cutting tool according to any one of the above (1) to (6), the insert may further include a second recessed portion located in the first surface, the second fixture may include a first arm portion and a second arm portion, the first arm portion may be engaged with the first recessed portion, and the second arm portion may be engaged with the second recessed portion.

(8) In the cutting tool according to the above (7), in a front view of the first surface, the through hole may be located between the first recessed portion and the second recessed portion.

(9) In the cutting tool according to the above (7) or (8), in a front view of the first surface, the through hole may be located on a virtual straight line passing through the first recessed portion and the second recessed portion.

(10) In the cutting tool according to any one of the above (1) to (9), the pocket may have a seat surface, the first surface may be in contact with the seat surface, the holder may include a body portion and a sheet member located on the seat surface, the sheet member may have a first sheet surface in contact with the second surface and a second sheet surface that is located on an opposite side of the first sheet surface and is in contact with the body portion and includes a sheet hole extending through the first sheet surface and the second sheet surface, and the second fixture may include an arm portion passing through the sheet hole and engaging with the first recessed portion.

(11) Rotating a workpiece, bringing the cutting tool according to any one of the above (1) to (10) into contact with the rotating workpiece, and separating the cutting tool from the workpiece may be included.

In the cutting tool 1A according to the first embodiment to the cutting tool 1C according to the third embodiment described above, positioning of the insert 5 can be performed by engagement of the arm portion 77 of the second fixture 7B with the recessed portion 57 of the insert 5. However, there is no particular limitation on the shape of the portion where the arm portion 77 and the recessed portion 57 are engaged with each other. For example, the insert 5 may include a protruding portion, the second fixture 7B may include a portion having a shape (a recess shape or the like) that can engage with the protruding portion, and the protruding portion of the insert and the portion of the second fixture may engage with each other to position the insert.

In the present disclosure, the invention has been described above based on the drawings and embodiments. However, the invention according to the present disclosure is not limited to the above-described embodiment. That is, the embodiments of the invention according to the present disclosure can be modified in various ways within the scope illustrated in the present disclosure, and embodiments obtained by appropriately combining the technical means disclosed in different embodiments are also included in the technical scope of the invention according to the present disclosure. In other words, note that a person skilled in the art can easily make different variations or modifications based on the present disclosure. Note that these variations or modifications are included within the scope of the present disclosure.

The embodiments according to the present disclosure are described above. However, the present disclosure is not limited to the aforementioned embodiments, and naturally includes various modifications within a scope that does not deviate from the spirit of the present disclosure.

### REFERENCE SIGNS

1A to 1C: Cutting tool
3: Body portion
3A: First end (Front end)
3B: Second end (Rear end)
3P: Center of body portion
5: Cutting insert (insert)
5P: Center of cutting insert (insert)
7: Fixture
7A: First fixture
7B: Second fixture
7BP: Center of second fixture
9: Body portion
11: Upper surface
13: Lower surface
15: Side surface
17: Head
19: Shank
21: Pocket
23: Seat surface
25: Restraint surface
27: First insertion port
29: Second insertion port
31: First opening portion
33: Second opening portion
35: First surface
35P: Center of first surface
37: Second surface
37P: Center of second surface
39: Third surface
41: Rake face region
43: Flank face region
45: Corner
45A: First corner
45AP: Center point of first corner
45B: Second corner
45BP: Center point of second corner
45C: Third corner
45CP: Center point of third corner
45D: Fourth corner
45DP: Center point of fourth corner
47: Side
47A: First side
47B: Second side
49: Cutting edge
49A: First cutting edge
49B: Second cutting edge
49Z: Corner cutting edge
51: Through hole
51P: Center of through hole
53: First port
55: Second port
57: Recessed portion
57A: First recessed portion
57AP: Center of first recessed portion
57B: Second recessed portion
57BP: Center of second recessed portion
59: Peripheral wall portion
59A: First peripheral wall portion
59B: Second peripheral wall portion
61: Bottom portion
63: First screw
65: Clamp bolt
67: Second screw
69: Clamp
69P: Center of clamp
71: Clamp through hole
71P: Center of clamp through hole
73: Inclined surface
75: Clamp inclined surface
77: Arm portion
77A: First arm portion
77B: Second arm portion
77P: Branch point of first arm portion and second arm portion
79: Engaging portion
81: Depression
83: Bottom
85: Strip-shaped region
87: Sheet member
89: First sheet surface
91: Second sheet surface
93: Third sheet surface
95: Sheet through hole
97: Clamp screw
97P: Center of clamp screw
99: Pull-in member
101: First contact surface
103: Second contact surface
105: First portion
107: Second portion
109: Sheet hole
201: Workpiece
O1: Reference axis
O2: Vertical axis
O3: Left-right axis
O4: Front-rear axis
O5: Rotation axis
L1, L3, L4: Virtual straight line
L2: Virtual line segment
L2P: Center point of virtual line segment
W: Width
Y1, Y2: Movement direction

1. A cutting tool extending from a front end toward a rear end along a reference axis, the cutting tool comprising:
a holder comprising a pocket located on a side of the front end;
an insert to be attached to the pocket; and
a plurality of fixtures for fixing the insert to the pocket, wherein
the insert has
a first surface and
a second surface located on an opposite side of the first surface and comprises
a through hole opening in the first surface and the second surface and
a first recessed portion located in the first surface, and
the plurality of fixtures comprise
a first fixture inserted into the through hole and
a second fixture engaged with the first recessed portion.

2. The cutting tool according to claim 1, wherein the recessed portion is located on a side of the rear end from a center of the insert.

3. The cutting tool according to claim 2, wherein
the first surface comprises a corner located on the side of the rear end, and
in a front view of the first surface, the first recessed portion is located on a virtual line segment connecting a central axis of the through hole and a center point of the corner.

4. The cutting tool according to claim 1, wherein in a front view of the first surface, the first fixture is located separated from the second fixture.

5. The cutting tool according to claim 1, wherein
the first recessed portion comprises
a bottom portion and
a peripheral wall portion connected to the bottom portion, and
the second fixture is in contact with the peripheral wall portion and is separated from the bottom portion.

6. The cutting tool according to claim 1, wherein
the second fixture comprises an engaging portion overlapping the first surface when the first surface is viewed from a plane perspective,
the engaging portion comprises a depression having a recessed shape toward the side of the front end, and
a bottom of the depression is located on the side of the front end from at least part of the first recessed portion.

7. The cutting tool according to claim 1, wherein
the insert further comprises a second recessed portion located in the first surface,
the second fixture comprises a first arm portion and a second arm portion,
the first arm portion is engaged with the first recessed portion, and
the second arm portion is engaged with the second recessed portion.

8. The cutting tool according to claim 7, wherein in a front view of the first surface, the through hole is located between the first recessed portion and the second recessed portion.

9. The cutting tool according to claim 7, wherein in a front view of the first surface, the through hole is located on a virtual straight line passing through the first recessed portion and the second recessed portion.

10. The cutting tool according to claim 1, wherein
the pocket has a seat surface,
the first surface is in contact with the seat surface,
the holder comprises
a body portion and
a sheet member located on the seat surface,
the sheet member has
a first sheet surface in contact with the second surface and
a second sheet surface that is located on an opposite side of the first sheet surface and is in contact with the body portion and
comprises
a sheet hole extending through the first sheet surface and the second sheet surface, and
the second fixture comprises an arm portion passing through the sheet hole and engaging with the first recessed portion.

11. A method for manufacturing a machined product, the method comprising:
rotating a workpiece;
bringing the cutting tool according to claim 1 into contact with the workpiece that is rotating; and
separating the cutting tool from the workpiece.
